(19) United States
(12) Patent Application Publication
(10) Pub. No.: US 2005/0145476 A1
(43) Pub. Date: Jul. 7, 2005

(54) Gaseous fuel production from fragmentary carbon-rich feedstock

(76) Inventor: Charles A. McClure, Lexington, VA (US)

Correspondence Address: Charles A. McClure, P. O. Box 1369, Lexington, VA, 24450, US

(21) Appl. No.: 10/750,393

(22) Filed: Dec. 31, 2003

(51) Int. Cl. B01J 19/08; B01J 19/12

(52) U.S. Cl. 204/164; 422/186.04

(57) ABSTRACT

Production of non-self-combustible gaseous product, combustible with added air or other oxygen source, by electric-arc processing of wetted fragmented carbon-containing feedstock (e.g., anthracite, or graphite, or residues of carbon) within enclosed high-temperature-resistant walls, thus defining a reaction zone wherein electric arcing of the wetted feedstock occurs. Included are specific methods of wetting the feedstock therein, and of generating electric arcing therethrough, forming desired gaseous product, and collecting same. Featured is a feedstock-compacting and electric-arcing module, also means and methods of juxtaposing its electrodes to such feedstock so as as to compact it and to produce an electric arc therethrough, thereby effectuating the desired conversion of water and such wetted feedstock into non-self-combustible gaseous form, combustible (with added air or other source of gaseous oxygen) into an environmentally friendly combustion effluent substantially free of noxious gases and substantially free of harmful liquid and solid particulates as well.

### TECHNICAL FIELD

This invention concerns conversion of fragmentary carbon-rich feedstock by electrical arcing into non-self-combustible gas whose air-combustion effluent is free from noxious gases and particulates.

### BACKGROUND OF THE INVENTION

Underwater arcing of carbon in rod or other continuous form to generate fuel is well known, as shown by the following U.S. Patents: Richardson U.S. Pat. Nos. 6,299,738 6,299,656; 6,263,838; 6,153,058; 6,113,748; 5,826,548; 5,792,435; 5,692,459; 5,435,274; Lee et al. U.S. Pat. No. 6,217,713; Dammann U.S. Pat. Nos. 6,183,608; 5,417,817 (et al.); U.S. Pat. No. 5,159,900; Eldridge 603,058.

### SUMMARY OF THE INVENTION

This invention enables commercially successful production of non-self-combustible gaseous fuel, combustible—upon addition of air or similar oxygen source—into heat and effluent substantially free of noxious gases, and free of liquid and solid particulates, by electrically converting wetted compacted fragmentary carbon-rich feedstock (e.g., anthracite, graphite, carbon residues) low in gross contaminants) into such environmentally beneficial gaseous product.

In semi-continuous operation, such conversion is achieved in a high-temperature reactor, by emplacing, compacting, and wetting such feedstock, exposing feedstock so treated to electrical arcing, thus evolving desired gaseous product, and collecting it thereabove. Any unconverted feedstock may be treated further, or may be replaced.

Feedstock is emplaced, manually or mechanically, to desired depth within such reaction zone, is wetted and is compacted therein as described below. Optimal depth depends upon carbon concentration and degree of fragmentation of the feedstock, preliminary wetting thereof, electrical conductivity of its constituent(s) so treated, the degree of indentation and/or penetration by the electrodes, and the voltage and timing of electrical power application thereto.

The extent of wetting of the fragmented feedstock may range from initial coating of its surface to complete flooding thereof, the latter generally being preferable eventually, if not initially.

Emplaced feedstock is wetted, as and when desired, via outlets from water piping in (or on) the reaction zone sidewalls, composed of heat-resistant materials and cooled by circulation of refrigerant liquids via (other) piping therein so as to protect them from the very high temperatures characteristic of electrical arcing.

This invention provides a compacting and arc-inducing module having three major components, comprising from top to bottom: (i) at fixed height, a reservoir, conveniently supported at a fixed level from the reactor sidewalls, into (and through) which water flows at a controllable rate; (ii) communicating with the reservoir base, the largest of several vertically telescoping hollow cylinders—their extension being determined by reservoir water pressure; and (iii) connecting with smallest cylinder's bottom end, hollow compressive-compacting plate (supported at controllable height determined by the extent of such telescoping) having an array of electrodes protruding downward from its lower face, and powered by positive (+) electrical connection from an (exterior) high-voltage, high-amperage source.

A pair of flexible electrical multi-conductors extend downward from laterally spaced wind-up supply rolls overhead, pass from top to bottom of the reservoir via respective vertical channels (dry) therethrough, and enter the top of a so supported hollow compacting and arcing electrode plate. Such electrical conductors terminate by connection with respective downward protruding electrodes thereof.

One or more negative (−) electrical conductors on (or in) the reactor floor provide(s) electrical grounding. Electrical arcing occurs in and through the intervening compacted wetted feedstock and thereby produces the desired gaseous product, which collects in the space above the feedstock. Such non-self-combustible gas is readily drawn off to be used then and there, or to be stored for later usage at the reactor location, or be sent by pipeline or by transport of suitable containers to storage and/or usage elsewhere.

### SUMMARY OF THE DRAWINGS

FIGS. 1A, 1B, & 1C are block diagrams of respective electrical, mechanical, and procedural components and steps, designated by words and/or symbols within the blocks or juxtaposed to intervening lines, for vertical compression and arcing of fragmented wet feedstock.

FIG. 2 is a sectional elevation of a reactor of this invention, featuring its feedstock-compacting and electric-arcing module having a water reservoir at a given fixed height and, suspended therefrom at controllable variable height by means of intervening telescoping cylinders, an electrode-carrying plate lowerable into compressive compacting and arcing contact with feedstock loaded therebelow.

FIG. 3 is an upward-looking sectional view taken at the level of a bottom-most cylinder in one such set, at (III-III) on FIG. 2.

FIG. 4 is an upward-looking bottom view of such electrode plate supported by the noted telescoping cylinders, at (IV-IV) on FIG. 3;

FIG. 5 is a side sectional elevation of one such electrode, with its downward protruding conical tip shown unsectioned; and

FIG. 6 is a side sectional view of an arc locus (and vicinity) between (i) a downwardly pointed conical high-voltage electrode such as shown in preceding views and (ii) an electrically grounded upwardly pointed multihedral electrode, within a mass of fragmented carbon feedstock, and exhibiting bubbles of desired gaseous product forming and/or formed alongside adjacent arcing feedstock fragments.

### DESCRIPTION OF THE INVENTION

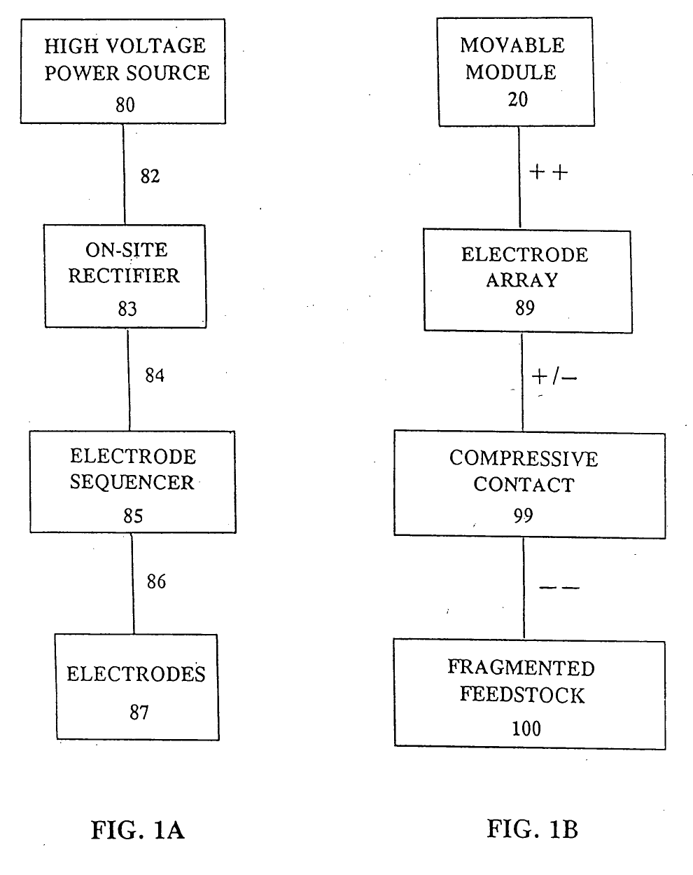

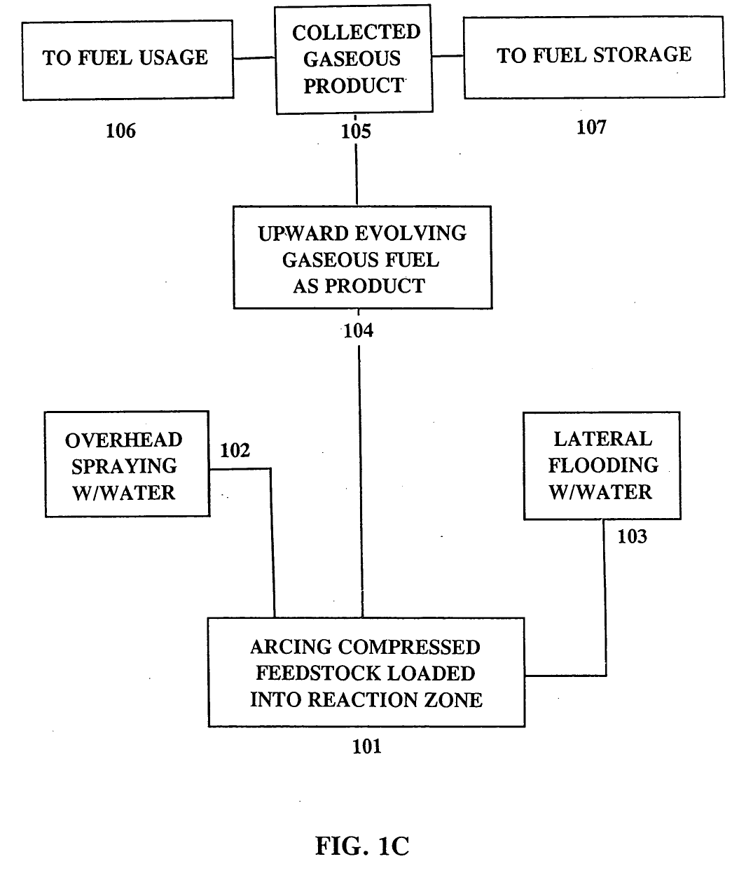

FIGS. 1A, 1B, and 1C are block diagrams denoting materials and related methods by words, reference numerals, and/or other symbols. Located within or closely adjacent to actual blocks they designate named activities, materials, etc. Spaced midway between blocks, they designate flow of input or output therebetween.

FIG. 1A shows High Voltage Power Source 80 with electrical lead(s) 82 down to On-Site Rectifier 83, leads 84 from there to Electrode Sequencer 85, then leads 86 to Electrodes 87.

FIG. 1B similarly shows Movable Module 20 at full height (++), with its suspended Electrode Array 89 at variable height (+/−), and further lowerable (−−) into Compacting or Compressive Contact 99 with Fragmented Feedstock 100 loaded therebelow.

FIG. 1C shows Upward Evolving Gaseous Fuel As Product 104 above Arcing Compressed Feedstock 101 so Loaded into Reaction Zone, under Overhead Water Spraying 102 and/or Lateral Flooding 103, becoming Upward Evolving Gaseous Fuel 104 and finally Collected Gaseous Product 105 for Fuel Usage 106 or Fuel Storage 107.

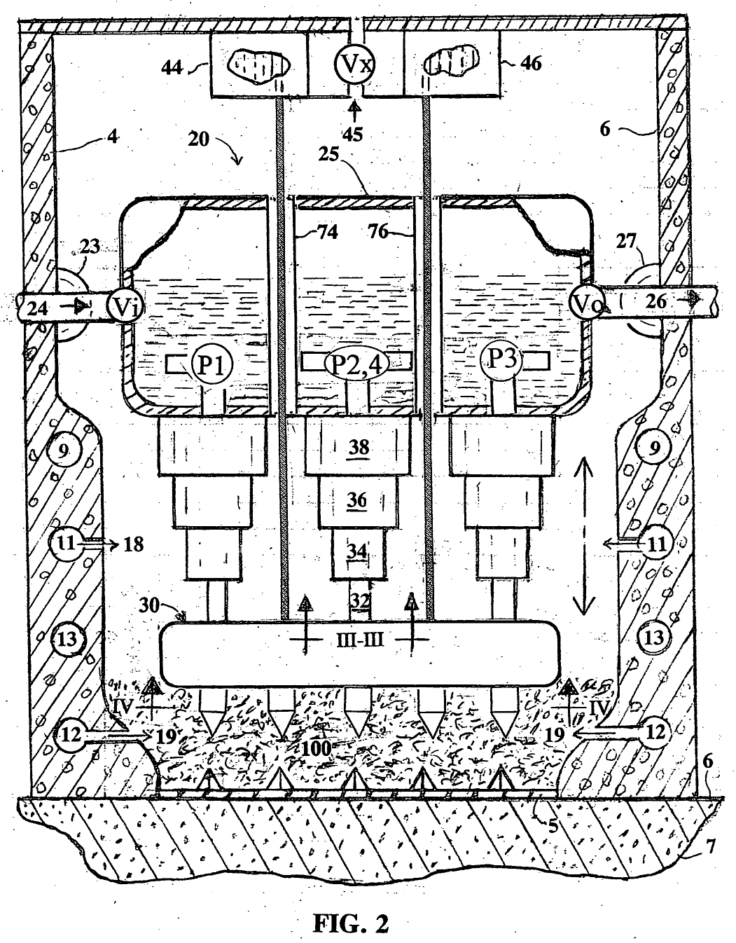

FIG. 2 is a sectional elevation of a reactor of this invention, featuring its feedstock-compacting and electric-arcing module having a water reservoir at a given fixed height and, suspended therefrom at controllable variable height by means of intervening telescoping cylinders, an electrode-carrying plate lowerable into compressive compacting and arcing contact with feedstock loaded therebelow.

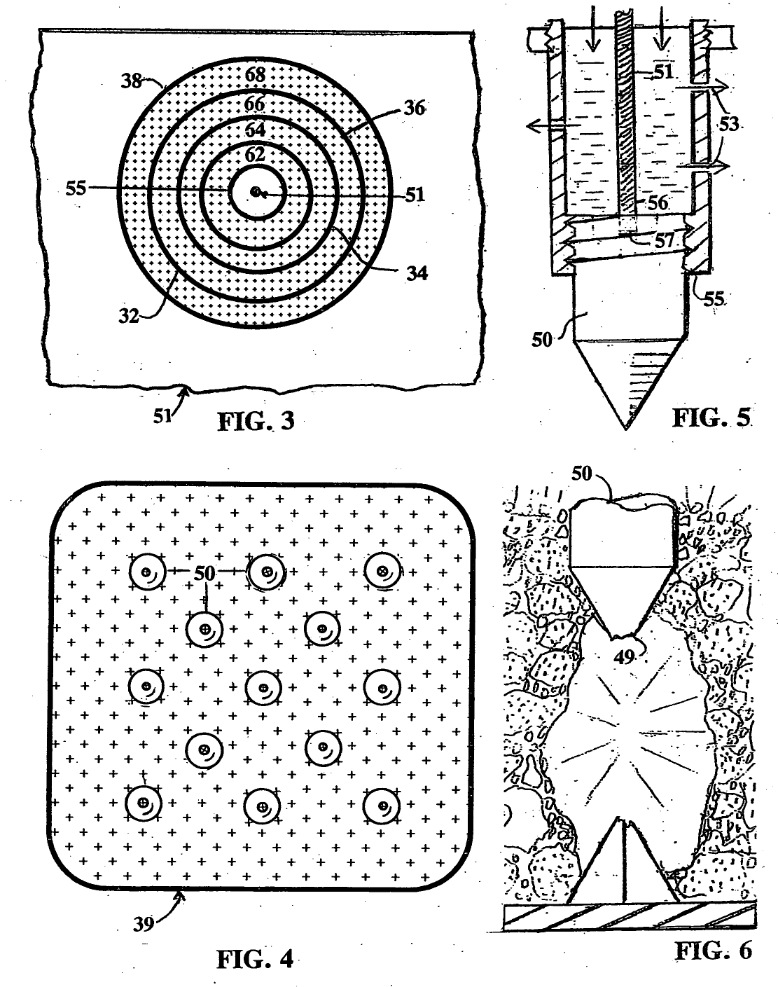

FIG. 3 is an upward-looking sectional iew taken at the level of a bottom-most cylinder in one such set, at (III-III) on FIG. 2.

FIG. 4 is an upward-looking bottom view of such electrode plate supported by the noted telescoping cylinders, at (IV-IV) on FIG. 3;

FIG. 5 is a side sectional elevation of one such electrode, with its downward protruding conical tip shown unsectioned; and

FIG. 6 is a side sectional view of an arc locus (and vicinity) between (i) a downwardly pointed conical high-voltgage electrode such as shown in preceding views and (ii) an electrically grounded upwardly pointed multihedral electrode, within a mass of fragmented carbon feedstock, and exhibiting bubbles of desired gaswous product forming and/or formed alongside adjacent arcing feedstock fragments.

### DESCRIPTION OF THE INVENTION

FIGS. 1A, 1B, and 1C are block diagrams denoting materials and related methods by words, reference numerals, and/or other symbols. Located within or closely adjacent to actual blocks they designate named activities, materials, etc. Spaced midway between blocks, they designate flow of input or output therebetween.

FIG. 1A shows High Voltage Power Source 80 with electrical lead(s) 82 down to On-Site Rectifier 83, leads 84 from there to Electrode Sequencer 85, then leads 86 to Electrodes 87.

FIG. 1B similarly shows Movable Module 20 at full height (++30), with its suspended Electrode Array 89 at variable height (+/−), and further lowerable (++) into Compacting or Compressive Contact 99 with Fragmented Feedstock 100 loaded therebelow.

FIG. 1C shows Upward Evolving gaseous Fuel as Product 104 above Arcing Compressed Feedstock 101 so Loaded into Reaction Zone, under Overhead Water Spraying 102 and/or Lateral Flooding 103, becoming Upward Evolving Gaseous Fuel 104 and finally Collected Gaseous Product 105 for Ruel Usage 106 or Fuel Storage 107.

FIG. 2 shows, in elevation and partly in section, reactor 10 with a U-shaped reaction zone bounded by left and right sidewalls 4 and 6 and metal electrical grounding strip 5 on floor 6 on ground 7.

Each sidewall contains upper and lower channels 9 and 13 therein for refrigerant from conventional exterior cooling means (not shown) circulated therein to protect the walls from heat damage during the frequent adjacent high-temperature electric arcing.

Each sidewall also contains upper and lower channels 11 and 12 from a conventional external water supply (not shown) to respective lateral outlets 18, 19 opening into the reaction zone, to enable wetting of feedstock 100 herein, from overhead and laterally, such as before and/or during—and/or after—protracted electric arcing.

Compacting and electric-arcing module 20 features reservoir 25, itself made of (or lined with) electrically non-conductive material, and retained between the respective sidewalls via collars 23 and 27 about adjacent in-wall water pipe end portions 24 and 26, which contain reservoir input valve Vi and output valve Vo, respectively. The reservoir contains four hydraulic lowering and raising pumps—P₁, P₂, P₃, and P₄ (latter's upper spout only shown).

Module 20 also features hollow (electrode-containing) plate 30 suspended, at adjustable height below the reservoir, by intervening sets of vertically telescoping close-fitting hollow cylinders. Each such set comprises four thereof, increasing via intermediate sizes, from 32 (the smallest) to successively larger 34 and 36 and ending with 38 (the largest) connecting at its top end to the reservoir underneath the down-spout of one of its pumps. Each of such downspouts may (or may not) extend down into its connecting cylinder.

Connecting each of the telescoping set's largest cylinders at its top to the reservoir, and of its smallest cylinder at its bottom to a matching top opening in the hollow electrode-containing plate, completes four go/return water paths between reservoir and plate.

To apply compacting force to underlying feedstock, the hollow plate is forced down by pumping water from the reservoir (with Vi open and Vo closed) via the lower/raise pumps into and so extending the telescoping cylinders. Reversing reservoir input/output valve settings (and, thus, the pumping direction) forces water from the plate back into—then out from—the reservoir, re-raising the plate.

FIG. 2 shows, in elevation and partly in section, reactor 10 with a U-shaped reaction zone bounded by left and right sidewalls 4 and 6 and metal electrical grounding strip 5 on floor 6 on ground 7.

Each sidewall contains upper and lower channels 9 and 13 therein for refrigerant from conventional exterior cooling means (not shown) circulated therein to protect the walls from heat damage during the frequent adjacent high-temperature electric arcing.

Each sidewall also contains upper and lower channels 11 and 12 from a conventional external water supply (not shown) to respective lateral outlets 18, 19 opening into the reaction zone, to enable wetting of feedstock 100 herein, from overhead and laterally, such as before and/or during—and/or after—protracted electric arcing.

Compacting and electric-arcing module 20 features reservoir 25, itself made of (or lined with) electrically non-conductive material, and retained between the respective sidewalls via collars 23 and 27 about adjacent in-wall water pipe end portions 24 and 26, which contain reservoir input valve Vi and output valve Vo, respectively. The reservoir contains four hydraulic lowering and raising pumps—P₁, P₂, P₃, and P₄ (latter's upper spout only shown).

Module 20 also features hollow (electrode-containing) plate 30 suspended, at adjustable height below the reservoir, by intervening sets of vertically telescoping close-fitting hollow cylinders. Each such set comprises four thereof, increasing via intermediate sizes, from 32 (the smallest) to successively larger 34 and 36 and ending with 38 (the largest) connecting at its top end to the reservoir underneath the down-spout of one of its pumps. Each of such downspouts may (or may not) extend down into its connecting cylinder.

Connecting each of the telescoping set's largest cylinders at its top to the reservoir, and of its smallest cylinder at its bottom to a matching top opening in the hollow electrode-containing plate, completes four go/return water paths between reservoir and plate.

To apply compacting force to underlying feedstock, the hollow plate is forced down by pumping water from the reservoir (with Vi open and Vo closed) via the lower/raise pumps into and so extending the telescoping cylinders. Reversing reservoir input/output valve settings (and, thus, the pumping direction) forces water from the plate back into—then out from—the reservoir, re-raising the plate.

FIG. 5 shows in longitudinal section, on a much larger scale, electrode housing 55 of FIG. 3 sectioned lengthwise, surrounding its (insulated) hot-wire 51, whose bottom end 56 seats in indentation 57 in the top of (otherwise unsectioned) conical electrode 50.

Housing 53 (sectioned lengthwise) exhibits lateral outlets or “weep holes” with flow arrows therethrough and into the surrounding water, whether within the plate or below it (as shown here). Any water so weeping into the plate may re-enter the reservoir via the cylinders, whenever subsequently re-telescoped. Water weep-exiting below the plate may be converted by the arcing into steam or even (along with feedstock carbon) into the desired gaseous product.

FIG. 6 shows electrical arc site between a downward protruding conical electrode tip 49 spaced above an upstanding quadrihedral tip 51 grounded by plate-like electrode 7 [in floor 8, not shown here]. As such arc 90 is blinding, it appears as a blank space (of rays).

Adjacent fragments of wet feedstock are shown as dark irregular blobs on which clearer beads of desired gaseous product are likely to appear as adjacent bubbles (99), which may collect initially thereon or therebetween. Such bubbles initially may expand in place by merging with adjacent visible bubbles (or invisible quantities) of gas, to rise and/or join otherwise unseen volumes thereof as an invisible blanket of the desired gaseous product overlying whatever unconverted feedstock or occluded impurities may remain thereunder.

Such product may be collected conveniently by first flooding the reaction zone—if not already flooded—via inwall water outlets 11, then opening outlet valve Vx in cover or roof 59, which otherwise seals the space overhead. A preferably oil-free gas-compressor (not shown) is useful in forwarding the collected gaseous product to a storage container, or via pipeline or vehicle to a usage location.

As fragmentary feedstocks, even with adequate concentrations of suitable carbonaceous materials, impose stringent requirements upon electric arcing, the noted step (99) of compacting such feedstock is undertaken mainly (not necessarily exclusively) before high-voltage arcing potential is provided to individual electrodes (50), as may be done randomly or in computerized sequence. During some or all of the time, some or all of the electrodes may be “hot”—whether fixed or varying in voltage—as may be preferred for a given feedstock.

Initial injection (as via in-wall water piping 54, 56) of a slightly conductive—otherwise inert—gas, such as helium or argon, and/or even so innocuous an electrolyte as acetic acid, may help to initiate, or even to maintain, the essential electrical arcing.

After feedstock arcing is deemed satisfactorily completed in any single run, voltage to the electrodes in the module plate is discontinued, and the module plate is raised from the feedstock remnants by withdrawing water from the extended telescoping cylinders.

The feedstock residue then may be recompacted to be treated further, or may be removed so as to be replaced by a new batch of the same or equivalent feedstock of fragmented carbon-rich composition. Such an interim also enables personal scrutiny or any pre-scheduled replacement of any excessively corroded or non-performing electrode. Though made of tungsten or its alloys with other stable heavy metals any electrode will corrode and/or wear away during repeated arcing.

The space overhead can be diminished by replacing the indicated fixed ceiling by a downwardly movable false ceiling—and by raising it gradually as the desired gaseous product is formed underneath it.

Additionally or alternatively, the feedstock may be blanketed with another relatively inert gas (e.g., carbon dioxide) or by otherwise delaying gaseous fuel production until substantially all air in the reaction zone has been superseded by blanketing or otherwise.

The preferably refrigerant-cooled reactor walls are composed of readily available high-temperature-resistant material(s), preferably ceramic or stone—or some combination thereof—thus rendering them adequately stable despite electric-arcing, wherein temperatures of thousands of degrees may be reached and persist for lengthy periods.

The conical and/or tetrahedral feedstock-contacting electrodes shown herein preferably comprise tungsten or its durable heavy-metal alloys selected to withstand the encountered electric-arcing and to provide an adequately functional operational lifetime. Nevertheless, they preferably are mounted for ready replacement, as may be needed.

Useful variations may be made in the subject invention, as by adding, combining, deleting, or subdividing apparatus, compositions, parts, or steps, while retaining many advantages and benefits of the herein described invention—itself being defined more specifically, as to its wide variety of useful aspects, in the following claims.

1. Method of converting fragmented, predominantly carbon, feedstock and water, within a localized electrically arcing reaction zone, into non-self-combustible gaseous form, combustible with added air—or equivalent source of oxygen—into effluents characterizable as substantially non-polluting, comprising the following steps:
(a) thoroughly wetting such fragmented feedstock; and
(b) compacting such wetted fragmented feedstock; and also
(c) subjecting such feedstock to electric arcing; and then
(d) collecting non-self-combustible gas emanating therefrom.

2. Method according to claim 1, including a step of subjecting the fragmented feedstock to compaction within the reaction zone at least once after each incremental increase (if any) in the number of individual batches of feedstock spread therein for treatment.

3. Method according to claim 1, wherein such wetting step is performed by spraying water thereonto within the reaction zone:
(i) from overhead, or (ii) laterally, or (iii) both (i) and (ii).

4. Method according to claim 3, wherein whatever manner of wetting is employed is effective to flood such feedstock with water.

5. Method according to claim 3, including subjecting such spray-wetted feedstock to electric arcing within the reaction zone.

6. Method according to claim 4, including subjecting such water-flooded feedstock to electric arcing within the reaction zone.

7. Method according to claim 1, including siting an available electrically grounded electrode along the base of the reaction zone.

8. Method according to claim 7, including supporting a nongrounded electrical lead to an electric-arc-producing module movable vertically within the reaction zone and thus lowerable therewithin into compressive contact with, and thereby effective to produce such electric arcing within, the wetted feedstock thereby grounded.

9. Method according to claim 7, including so supporting such compaction module adjustably in height within the reaction zone, and moving it vertically, so supported, via self-contained drive means.

10. Reactor for practicing the method of claim 1, comprising a pair of spaced-apart upstanding walls, composed of temperature-resistant material, and having supported therebetween a feedstock-compacting and electric-arcing module, adjustable vertically both upward above and downward into compressive contact with feedstock.

11. Reactor according to claim 10, wherein such module is provided with horizontally opposed means for supporting such module vertically movable between such walls.

12. In a reactor for producing non-self-combustible fuel in gaseous form, combustible with added air, or equivalent source of oxygen, into substantially non-polluting combustion effluents only, a movable module adapted to compact fragmented mainly carbon feedstock therein, and further adapted when lowered into compressive contact therewith to produce electric arcing within and throughout such feedstock, thereupon producing such gaseous fuel therefrom.

13. Method of producing non-self-combustible gaseous fuel, combustible with air, comprising the step of electric arcing within compacted fragmented substantially carbon-rich water-wetted feedstock.

14. Non-self-combustible gaseous fuel, combustible with added air into substantially non-polluting combustion effluents only, from electric arcing through water-wet fragmented carbon-rich feedstock.

15. Method of obtaining the non-self-combustible non-polluting fuel of claim 14, comprising the steps of electrically arcing compressed fragmented carbon-rich feedstock flooded with water.

16. A reactor for processing fragmentary carbon feedstock into non-self-combustible fuel gas (combustible with a subsequently added source of gaseous oxygen), comprising enclosing walls of high-temperature-resistant material, and including the following:
a. a reaction zone therein wherein the feedstock is treated, provided with electrical grounding means along the base of the zone;
b. refrigerant circulating within the enclosing walls of the reaction zone, for retention of structural integrity despite high temperatures resulting from electrical arcing of the feedstock;
c. piping means effective to provide water within the reaction zone, for wetting the fragmented feedstock therewithin;
d. means movable vertically therein effective to compact feedstock wetted and subjected to electrical arcing therein; and
e. means effective to provide electrical arcing treatment of wetted feedstock therein, thereby vaporizing feedstock plus adjacent water into the desired non-self-combustible gaseous product—whose own combustion effluent is substantially free of noxious gases, and similarly free of liquid particulates and of solid particulates.

17. Reactor means according to claim 16, wherein such between-walls compacting means is adapted to move vertically, within the reaction zone, onto feedstock to be converted therein—along with water—into gaseous fuel, to compress the feedstock, including means effecting such movement and such compaction, as and when desired.

18. Reactor means according to claim 18, wherein such between-walls compacting means is also adapted to move horizontally, as and whenever and wherever desired, along and above such feedstock to be converted into such fuel.

19. Reactor means according to claim 16, wherein such between-walls electrical-arcing means is adapted to move vertically and also preferably horizontally, within the reaction zone, to juxtapose an arc-producing electrode thereof to feedstock to be converted along with water into gaseous fuel, and including means effecting such movement, as well as such arcing, as and whenever desired.

20. Non-self-combustible gas, combustible with addition of air or other source of gaseous oxygen, having emanated from feedstock within the reactor means of claim 16, during its normal operation, and having been collected and stored for optional future combustion.
